(19) United States
(12) Patent Application Publication
(10) Pub. No.: US 2022/0277942 A1
(43) Pub. Date: Sep. 1, 2022

(54) Methods and Apparatus for Improved Pumping of Ion Detector

(71) Applicant: Adaptas Solutions Pty Ltd, Clyde, New South Wales (AU)

(72) Inventors: Kevin Hunter, Clyde, New South Wales (AU); Russell Jurek, Clyde, New South Wales (AU)

(21) Appl. No.: 17/637,313

(22) PCT Filed: Aug. 24, 2020
(86) PCT No.: PCT/AU2020/050886

§ 371 Date: Feb. 22, 2022

(30) Foreign Application Priority Data
Aug. 26, 2019 (AU) 2019903116

(51) Int. Cl. H01J 49/00; H01J 49/40; H01J 49/42

(52) U.S. Cl. CPC H01J 49/0031; H01J 49/401; H01J 49/427

(57) ABSTRACT

A method for operating scientific analytical equipment such as mass spectrometers for the purpose of improving the performance and/or service life. Such method may include: providing an ion stream comprising ions having a range of masses, separating the ions of the ion stream on the basis of mass, and controlling the timing and/or order of impact of the separated ions on an electron emissive surface of the ion detector so as to modify one or more parameters of the ion detector.

### FIELD OF THE INVENTION

The present invention relates generally to the operation of scientific analytical equipment. More particularly, the invention relates to methods of operating instruments which separate particles on the basis of mass, such as mass spectrometers. Such methods are for the purpose of improving the performance and/or service life of an ion detector. Apparatus configured to be operable according the methods of the invention are also provided.

### BACKGROUND TO THE INVENTION

In a mass spectrometer, the analyte is ionized to form a range of charged particles (ions). The resultant ions are then separated according to their mass-to-charge ratio, typically by acceleration and exposure to an electric or magnetic field. The separated signal ions are caused to enter a detector. The detector normally comprises some means for amplifying the ion signal. The amplification means may be a series of dynodes arranged in an electron amplification chain as is well known in the art. In a detector, the amplified electron signal impacts on a terminal anode which outputs an electrical signal proportional to the number of electrons which impact it. The signal from the anode is conveyed to a computer where it is displayed as a mass spectrum of the relative abundance of detected ions as a function of the mass-to-charge ratio.

Spectra output in mass spectrometry are used to determine the elemental or isotopic signature of a sample, the masses of particles and of molecules, and to elucidate the chemical structures of molecules and other chemical compounds.

For many types of mass spectroscopy, the separated ion species are each directed in turn into the detector. This process is often termed “scanning” or “sweeping” the mass spectrum. As one example, a transmission quadrupole mass analyser scans a mass spectrum by the use of oscillating electrical fields to selectively stabilize or destabilize the paths of ions passing through a radio frequency quadrupole field created between four parallel rods. Only ions within a certain mass/charge ratio range are passed at any one time, however changes to the potentials on the rods allow for a wide range of m/z values to be scanned rapidly.

Scanning is routinely achieved by changing the rod potentials such that ions of sequentially increasing or decreasing m/z value are brought to impact on the detector. Reference is made to FIG. 1 which shows a mass spectrum from a quadrupole mass analyser in scan mode, where the ion peaks exit the quadrupole sequentially by increasing mass. In this example, the sample (when ionized) provides 20 discrete ionic masses of varying signal level. The peaks are labelled with their mass number. It will be noted that some peaks do not contain any signal (6, 11, 13 and 14).

It is a problem in the art that the performance of electron emission-based detectors used in mass spectrometers degrade over time. It is thought that secondary electron emission reduces over time causing the gain of the electron multiplier to decrease. To compensate for this process, the operating voltage applied to the multiplier must be periodically increased to maintain the required multiplier gain. Ultimately, however, the multiplier will require replacement. It is noted that detector gain may be negatively affected both acutely and chronically.

Prior artisans have addressed the problems of dynode ageing by increasing dynode surface area. The increase in surface area acts to distribute the work-load of the electron multiplication process over a larger area, effectively slowing the aging process and improving operating life and gain stability. This approach provides only modest increases in service life, and of course is limited by the size constraints of the detector unit within a mass spectrometry instrument.

In continuous electron multipliers (CEM) such as channeltrons, prior artisans have attempted to increase emissive surface area by the use of elliptical cross-sections in place of the art-accepted circular design. While an increase in service life was noted, the increase was not proportional to the surface area increase. Accordingly, one or more factors other than surface area appear to have an influence on service life.

It is also a problem in the art that the performance of electron emission-based detectors can degrade more rapidly in gain during the initial stages of their service life. This initial gain loss is sometimes referred to as “burn-in.” Prior artisans have addressed this issue by employing an initial intense period of operation so as to rapidly overcome the “burn-in” period before the instrument is used for actual analysis work. While effective, this approach takes time and effort and delays the implementation of a new detector.

It is an aspect of the present invention to overcome or ameliorate a problem of the prior art by providing a detector having an extended service life, and/or improved performance It is a further aspect to provide a useful alternative to the prior art.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

In a first aspect, but not necessarily the broadest aspect, the present invention provides a method for operating an ion detector, the method comprising the steps of:

providing an ion stream comprising ions having a range of masses, separating the ions of the ion stream on the basis of mass, and controlling the timing and/or order of impact of the separated ions on an electron emissive surface of the ion detector so as modify one or more parameters of the ion detector.

In one embodiment of the first aspect, one of the one or more parameters of the ion detector is electron flux.

In one embodiment of the first aspect, one of the one or more parameters of the ion detector is the time that the electron emissive surface is impacted with ions during detector run time, compared with the time the detector is not impacted with ions during detector run time.

In one embodiment of the first aspect, one of the one or more parameters of the ion detector is the level of detector pumping.

In one embodiment of the first aspect, one of the one or more parameters of the ion detector is the level of fouling of the electron emissive surface with a contaminant.

In one embodiment of the first aspect, the detector is configured to define an internal detector environment and an external detector environment, and one of the one or more parameters of the ion detector is the equilibrium state between the internal detector environment and the external detector environment.

In one embodiment of the first aspect, the detector is configured to define an internal detector environment and an external detector environment, and one of the one or more parameters of the ion detector is the coupling or uncoupling of the internal detector environment and the external detector environment.

In one embodiment of the first aspect, one of the one or more parameters of the ion detector is a performance parameter, and the modification is an improvement in the performance parameter.

In one embodiment of the first aspect, one of the one or more parameters of the ion detector is a service life parameter, and the modification is an improvement in the service life parameter.

In one embodiment of the first aspect, the method comprises the step of controlling the impact of the separated ions on the electron emissive surface such that the sequence of ion species impacting is such that the order of at least three of the ion species is not in an ascending or descending order according to mass.

In one embodiment of the first aspect, the method comprises the step of controlling the impact of the separated ions on the electron emissive surface such that: p (i) the sequence of ion impact is modified compared with a method of operation whereby ions impact in ascending or descending sequence according to mass, and/or

(ii) the sequence or ion impact is modified so as to form an ion signal maximum, and/or

(iii) the timing of ion impact is modified according to the timing of a relaxation period of the detector, and/or

(iv) the timing of ion impact is modified so as to shorten or lengthen the time period between the impact of two ions of different mass.

In one embodiment of the first aspect, the modification is compared to a method of detector operation whereby (a) ions impact in ascending or descending sequence according to mass or (b) ions impact at a time according to a linear scanning of the ion stream.

In a second aspect, the present invention provides a method for operating an ion detector, the method comprising the steps of: p providing an ion stream comprising ions having a range of masses,

separating the ions of the ion stream on the basis of mass,

controlling the sequence and/or timing of impact of the separated ions on an electron emissive surface of the ion detector so as to regulate the time that the detector is impacted with ions compared with the time the detector is not impacted with ions during detector run time.

In one embodiment of the second aspect, the regulation is an upregulation or downregulation in the time that the detector is impacted with ions.

In one embodiment of the second aspect, the upregulation is an increase in detector run time that the detector is impacted with ions compared with a comparable method of operation where no such controlling and regulation is included in the method, and the downregulation is a decrease in detector run time that the detector is impacted with ions compared with a comparable method of operation where no such controlling and regulation is included in the method.

In one embodiment of the second aspect, the comparable method of operation comprises sequentially impacting a mass range of separated ions on the electron emissive surface of the ion detector in an ascending or descending order according to mass.

In one embodiment of the second aspect, the mass range of separated ions covers at least 20%, 40%, 40%, 50%, 60%, 70%, 80% or 90% of all masses of ions in the ion stream.

In one embodiment of the second aspect, the ion detector is structured so as to provide an internal detector environment and an external detector environment, and wherein the step of controlling causes an alteration in the coupling between the internal detector environment from the external detector environment.

In one embodiment of the second aspect, the alteration in the coupling is a decrease in the level of coupling between the internal detector environment from the external detector environment.

In one embodiment of the second aspect, the ion detector is structured so as to provide an internal detector environment and an external detector environment, and wherein the step of controlling causes an alteration in pumping of the internal detector environment to the external detector environment.

In one embodiment of the second aspect, the alteration in pumping is an increase in pumping of the internal detector environment.

In one embodiment of the second aspect, the ion detector is structured so as to provide an internal detector environment and an external detector environment, and wherein the step of controlling causes an alteration in the time for which an equilibrium is established and/or re-established between the internal detector environment and the external detector environment after an alteration in coupling between the internal detector environment to the external detector environment.

In one embodiment of the second aspect, the alteration in the time for which an equilibrium is established and/or re-established between the internal detector environment and the external detector environment is an increase in time.

In one embodiment of the second aspect, the step of controlling controls the timing of impact of ions on the electron emissive surface of the ion detector.

In one embodiment of the second aspect, the timing of impact of ions on the electron emissive surface of the ion detector is such that the order of impact of ions is not sequential according to the masses of the ions.

In one embodiment of the second aspect, the order of impact of ions in a group of 2, 3, 4, 5, 6, 7, 8, 9, or 10 ions is not sequential according to the masses of the ions within the group. In addition or alternatively, the order of impact of groups of 2, 3, 4, 5, 6, 7, 8, 9, or 10 ions is not sequential according to the masses of the ions across the groups.

In one embodiment of the second aspect, the timing of impact of ions on the electron emissive surface of the ion detector is such that the interval between any two or more ions impacting is altered as compared to the situation where the ion stream is scanned in an ascending or descending manner by mass.

In one embodiment of the second aspect, the timing of impact of ions on the electron emissive surface of the ion detector is such that the intervals between any 3, 4, 5, 6, 7, 8, 9, 10 or more ions impacting is altered as compared to the situation where the ion stream is scanned in an ascending or descending manner by mass.

In one embodiment of the second aspect, the interval between any two or more ions impacting is decreased as compared to the situation where the ion stream is scanned in an ascending or descending manner by mass.

In one embodiment of the second aspect, the timing of impact of ions on the electron emissive surface of the ion detector is such that a series of ions form an ion signal maximum.

In one embodiment of the second aspect, the ion signal maximum has a maximum at the start of a series of ion signals.

In one embodiment of the second aspect, the method comprises the step of altering the order of impact of ions on the electron emissive surface of the ion detector so as to differ from the order impact as compared to the situation where the ion stream is scanned in an ascending or descending manner by mass.

In a third aspect, the present invention provides an analytical instrument comprising: p sample ionization means,

ion directing means,

ion controlling means, and

ion detection means,

wherein the ion directing means is configured to direct an ion stream from the sample ionization means toward the ion detection means, and the ion controlling means is configured so as to alter a parameter of the ion detection means.

In one embodiment of the third aspect, the ion controlling means is configured to alter the order of impact of ions on the ion detection means so as to differ from the order of impact where the ion stream is scanned in an ascending or descending manner by mass.

In one embodiment of the third aspect, the ion controlling means is configured to alter the timing of impact of ions on the ion detection means so as to differ from the timing of impact where the ion stream is scanned in an ascending or descending manner by mass.

In one embodiment of the third aspect, the ion controlling means is configured to execute a method according to any embodiment of the first or second aspects.

In one embodiment of the third aspect, the analytical instrument is a mass spectrometer.

In one embodiment of the third aspect, the mass spectrometer operates on a time-of-flight basis.

In one embodiment of the third aspect, the mass spectrometer comprises a quadrupole mass analyzer.

### BRIEF DESCRIPTION OF THE FIGURES

FIG. 1 illustrates quadrupole mass spectrometer output of the type typical in the prior art showing mass peaks arising from the sequential impact of ions on a detector surface in order of increasing mass.

FIG. 2 illustrates quadrupole mass spectrometer output, whereby the ions impact on a detector surface run-time in an order which is sequential according to mass. In run-time, the ions with signal are “bunched” together so as to minimise the time between arrival of ions. Ideally, the time between arrival of ions at different masses is less than the detector relaxation time, as shown in this Figure. A secondary goal is to bunch together ions with no or negligible ion signal. In this way, the unavoidable time when no ions arrive (because it is necessary to keep scanning those masses and factor in system overheads), during which time the internal and external detector environments re-equilibrate, is turned into a single interval. Once three-times the relaxation time is exceeded there is no further detriment in a longer interval without ions arriving. It will be appreciated that the order of impact is a rearrangement of the strictly mass-sequential order of exit of ion masses shown in FIG. 1.

FIG. 3 illustrates quadrupole mass spectrometer output, whereby the ions impact on a detector surface run-time in an order which is generally sequential according to mass (the exception being ions masses 13 and 14), with ion masses impacting according to a time scheme so as to avoid the time between ion impacts exceeding the relaxation time of the detector. This preserves a significant fraction of the superior internal environment created inside the detector during operation when ions arrive.

FIG. 4 illustrates quadrupole mass spectrometer output, whereby the ions impact on a detector surface in run-time in an order such that ions are grouped to form a series of spiked-arrangement (in terms of signal) It is expected that this spiking will maximise the detector's ability to pump its' internal volume as ions of different masses and signal strength arrive.

FIG. 5 illustrates quadrupole mass spectrometer output, whereby the ions impact on a detector surface in run-time in an order such that ions are grouped to form a single spiked-arrangement, the spiked group being separate from ion masses having no signal. Bunching ions to form a spiked group maximises pumping of the detector's internal volume. The situation shown in this Figure is essentially a combination of FIG. 2 and FIG. 4 in so far as the strategy is to minimise the time between ion arrivals at different masses, while simultaneously using spiking to maximise the detector's pumping effect.

FIG. 6 illustrates quadrupole mass spectrometer output, whereby the ions impact on a detector surface in run-time in an order such that ions are grouped to form a series of spiked-arrangements, the spiked group being output according to a time scheme so as to avoid the time between ion impacts exceeding the relaxation time of the detector. The situation shown in this Figure is essentially a combination of FIG. 3 and FIG. 4 in so far as the strategy is to arrange the ion arrivals into groups, such that the maximum time between the arrival of ions does not exceed the detector relaxation time. Simultaneously, the ions within each group are formed into a spike so as to maximise the detector's pumping during each group.

### DETAILED DESCRIPTION OF THE INVENTION

After considering this description it will be apparent to one skilled in the art how the invention is implemented in various alternative embodiments and alternative applications. However, although various embodiments of the present invention will be described herein, it is understood that these embodiments are presented by way of example only, and not limitation. As such, this description of various alternative embodiments should not be construed to limit the scope or breadth of the present invention. Furthermore, statements of advantages or other aspects apply to specific exemplary embodiments, and not necessarily to all embodiments covered by the claims.

Throughout the description and the claims of this specification the word “comprise” and variations of the word, such as “comprising” and “comprises” is not intended to exclude other additives, components, integers or steps.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

The present invention is predicated at least in part on the inventors' discovery that a detector may function as a pump during operation, that pumping function being capable of exploitation as a means for cleaning, or maintaining a clean internal detector environment. The pumping function causes the internal and external detector environments to move away from an equilibrium condition whereby a contaminant is equally likely to enter the internal detector environment as another is to leave the internal detector environment. The vacuum conductance of the detector determines how long it takes for gas in the external environment to reach the internal environment of the detector (which we characterise using the detector ‘relaxation time’) and re-establish equilibrium. The longer it takes to re-establish equilibrium, the longer the detector can operate with a superior internal environment.

The contaminant may be a carrier gas (such as hydrogen, helium or nitrogen) used to conduct sample to the ionization means of a mass spectrometer continues beyond the mass analyser and toward the ion detector. Alternatively, the contaminant may be an atom, molecule or particle carried by the carrier gas. In other scenarios, the contaminant is unrelated to the carrier gas and appears about the detector by some other means. In any event, the contaminant has the propensity to negatively affect a functional surface of the detector (such as an electron emissive surface or a collector/anode surface) upon contact therewith.

While the invention primarily relates to the exploitation of detector pumping by the judicious regulation of ion impact on the detector during run-time, other means for improving the detector interior environment may be used in combination. For example, directing the flow of carrier gas away from the detector or regulating the vacuum conductance of the detector may augment the advantage provided by detector pumping alone.

The contamination of detector surfaces mentioned above has acute negative effects (transiently altering the performance of the detector) but also more chronic negative effects which leads to long term performance deficiencies and a decrease in detector service life. Applicant provides that ion detector performance and/or service life may be improved where ions are impacted on an electron emissive surface of the detector in a manner that facilitates detector pumping. The structure of the detector may then influence how readily a contaminants flows from the detector external environment to the detector internal environment. Preferably, the detector is structured to have a low vacuum conductance thereby inhibiting the flow of contaminants into the detector. In addition or alternatively, facilitation of pumping may hasten the exit of a contaminant from the internal environment of the detector to the external environment. In another scenario, the pumping may cause a transition away from an equilibrium state or delay the return of an equilibrium state between the internal and external detector environments.

The present invention provides novel means for excluding contaminants from the internal detector environment so as to maintain a cleaner environment about the electron emissive and electron collector surfaces of an ion detector.

This cleaner internal environment primarily extends the service life of the detector. The secondary benefits, depending on how the detector is operated, also include reduced noise, greater sensitivity, increased dynamic range and reduced ion feedback.

According to the present invention, detector pumping in run time is improved by judiciously ordering and/or timing ion impact on the detector electron emissive surface. This approach is distinct from the prior art whereby the ion stream is scanned in run time to focus ions in order of mass (ascending to descending, or descending to ascending) such that ion impact of the detector electron emissive surface is in sequential mass order. In terms of the judicious timing of ion impact in run time, the present invention differs from the prior art in that timing is controlled so as ions are grouped or separated according to mass signal (or lack of mass signal).

As will be appreciated, the control of ion impact may have effect in terms of both ordering and timing. For example, an ion of higher mass may “leapfrog” an ion of lower mass (or vice versa) thereby departing from the sequential ordering of ions according to mass. In that circumstance, the ions are re-ordered by delaying (in time) the impact of one ion to allow “leapfrogging” of the other.

For example, timing the impact ions having a high abundance concentrates electron flux in the detector over a short time period, thereby creating a high level of secondary electron flux and therefore a higher level pumping. This high level of pumping in turn assists in purging the detector internal environment, thereby facilitating exit of contaminants therefrom, or preventing entry of contaminants thereinto.

Considered from another perspective, the high level of pumping may act to uncouple the internal and external detector environments, or to transition the internal and external detector environments away from an equilibrium state, or further away from an equilibrium state.

In any event, a more pristine environment within the detector is encouraged by improving detector pumping.

In another alternative, the timing of ion impact is modified such that high levels of electron flux are present just before the detector is in a relaxation period, which is the period in which it takes a substantially perfect vacuum formed inside a detector to equalise with the external environment. During the relaxation period, contaminants are more likely to pass from the external detector environment to the internal detector environment, and so maintaining electron fluxes high before relaxation periods causes high level uncoupling of the internal and external detector environments (i.e. moves the environments further away from equilibrium) such that during a relaxation period the environments are less likely to move back to an equilibrium state. When in an equilibrium state, contaminants may diffuse freely between the internal and external detector environments thereby increasing the probability of a contaminant contacting and becoming chemically “stitched” to a detector surface, which converts physi-sorbed contaminants into chemi-sorbed contaminants. By definition, the equilibrium state corresponds to equal rates of contaminants entering and leaving the internal detector environment. Accordingly, the equilibrium state is likely to produce the maximum net disposition of contaminants on detector surfaces and is therefore to be avoided.

In another alternative, the timing of ion impact is modified such that high abundance ions are caused to impact a detector surface initially, and lower abundance ions impact thereafter in order of decreasing abundance. This has the effect of causing an immediate and high level of detector pumping over a short period, thereby more effectively purging the internal detector environment than would result where the ion masses were not impacted with regard to signal level.

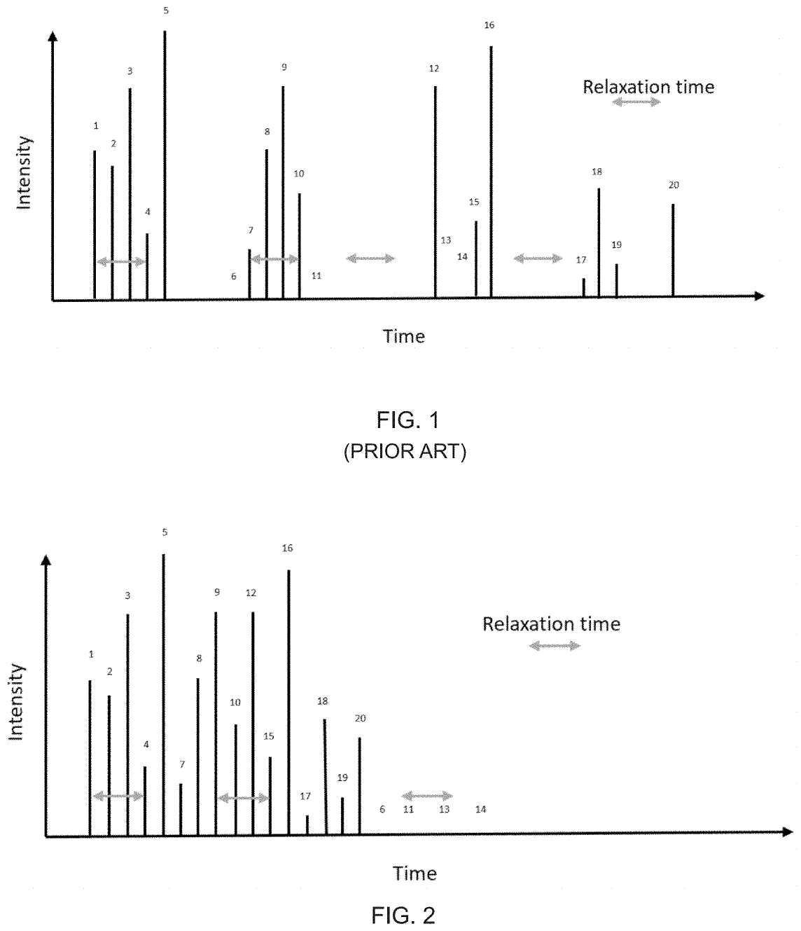

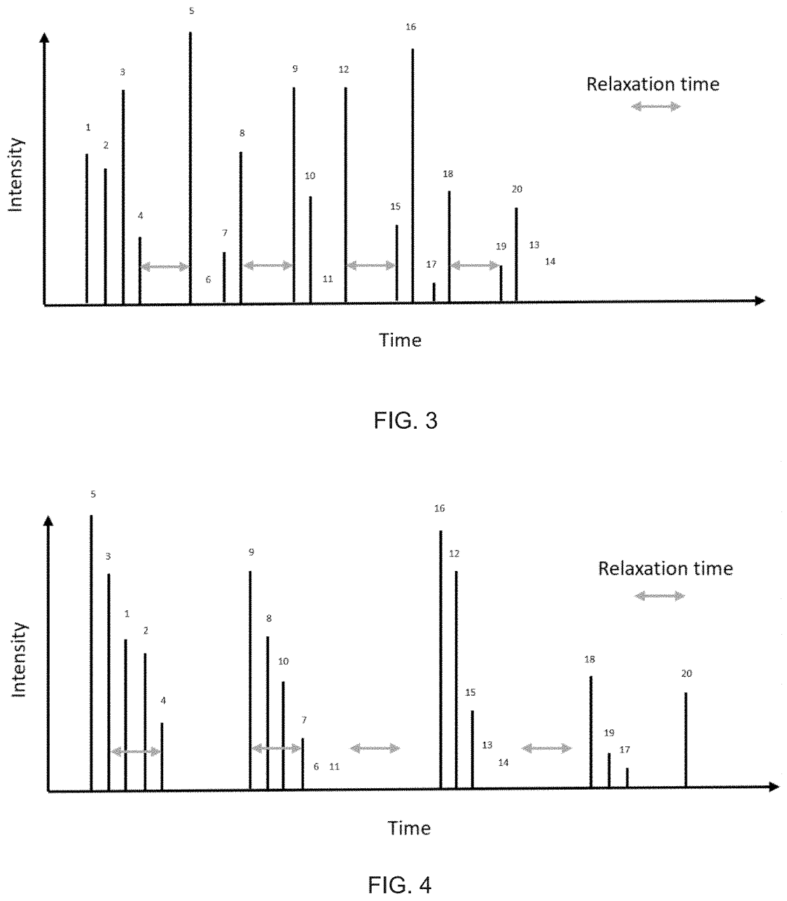

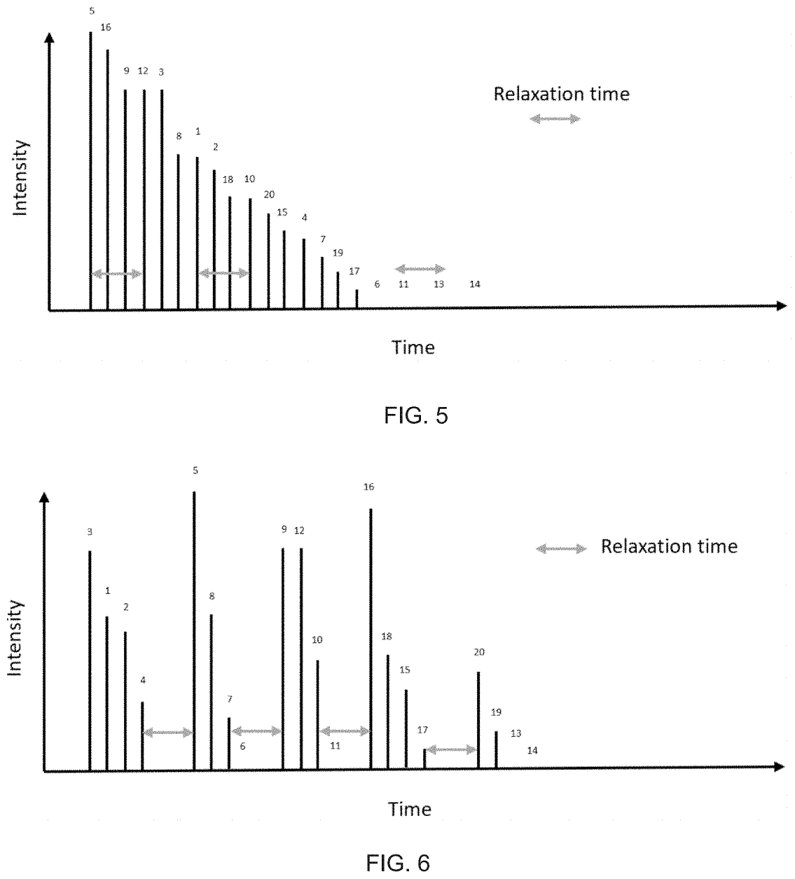

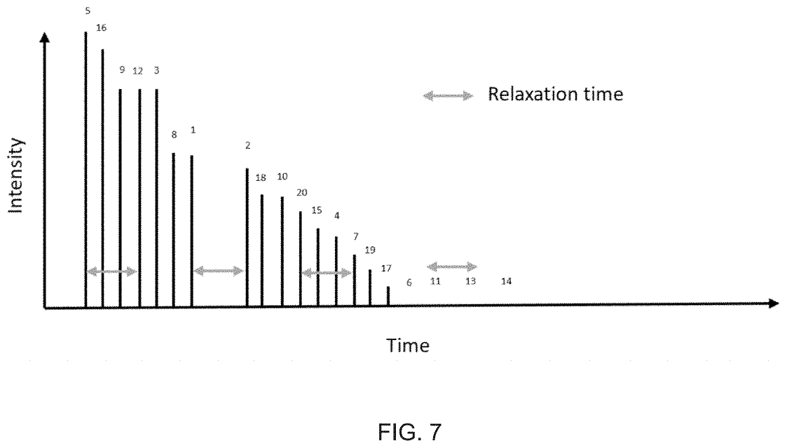

The present methods will typically comprise, as a first step a preliminary analysis of the mass composition of the analyte under consideration. Typically, the methods will be implemented on a mass spectrometer and in which case a regular scan across the expected mass range may be performed, to provide a spectrum of the kind shown in FIG. 1. The spectrum is used as a starting point in deciding how best to modify the order and/or timing of impact of each of the ion masses during the following run time step. Such a decision may be made by human assessment of the spectrum, or more commonly by software-encoded algorithmic means.

Once the decision as to how best reorder and/or retime the impact of the various ion masses in the sample has been made, the mass spectrometer changes to run time mode and the sample is analysed.

In some embodiments of the method, the preliminary analysis step described above is unnecessary and modification of the order and or time of ion impact is made according to previous experience with a similar sample, or a prediction based on knowledge of the likely mass composition of a sample.

In run time operation, the mass analyser of the mass spectrometer is controlled to effect the required order and/or timing of ion impacts on an electron emissive surface of the detector. As appreciated by the skilled person, the mass analyser is a component of a mass spectrometer responsible for selecting ions based on their mass-to-charge ratio. Some mass analysers actively select a specific mass to transmit to the detector. Examples of this are mass spectrometers that use quadrupoles. In these systems it is possible to control the sequence of ion masses that are transmitted to the detector. Typically, the accessible mass range is repeatedly scanned in either an ascending or descending fashion. The term “scan” is used in the art to refer to this sequential mass scanning.

For example, a mass analyser may be a quadrupole which separates ions based on their relative stabilities of their trajectories in the oscillating electric fields that are applied to the rods of the quadrupole. Selection of a given mass (or a narrow mass range) across the expected broad mass range by the quadrupole is typically effected by computer control, and therefore may be under software control.

The present invention is operable with types of mass analysers other than a quadrupole, and given familiarity with all types of mass analysers the skilled person is amply enabled to apply the invention to a broad range of analyser types having the benefit of the present specification.

The present methods may be applied to prior art ion detectors installed in prior mass spectrometry instruments. The present methods may be implemented in the form of software comprising program instructions to perform any of the required method steps. The program instructions may be part of a mass spectrometer system comprising hardware components (including a computer processor) and program instructions stored in electronic memory associated with the processor.

In some embodiments the ion detector to which the present methods may be applied is a prior art detector. Preferably, however, the detector has physical characteristics which favour uncoupling of the internal detector environment from the external detector environment. The physical characteristics act in concert with the improved functioning of the detector according to the present methods to decrease the opportunity for fouling of electron emissive and electron collection surfaces of the detector.

In one embodiment the ion detector is configured so as to allow for user control of the environment about the electron emissive surface(s) and/or the electron collector surface Such that the environment about the electron emissive surface(s) is different to the environment immediately external to the enclosure.

The ion detector may comprise an enclosure configured to facilitate establishing and/or maintaining a difference in the environments about (i) the electron emissive surface(s) and/or the electron collector surface and (ii) the environment immediately external to the detector.

The ion detector may comprise means for establishing an environment about the electron emissive surface(s) and/or the electron collector surface which is different to the environment immediately external to the enclosure.

The ion detector may comprise means for user control of the environment about the electron emissive surface(s) and/or the electron collector surface such that the environment about the electron emissive surface(s) is different to the environment immediately external to the enclosure.

The ion detector may be physically configured such that the environment about the electron emissive surface(s) and/or the electron collector surface is different to the environment immediately external to the enclosure with regard to: the presence, absence or partial pressure of a gas species in the respective environments; and/or the presence, absence or concentration of a contaminant species in the respective environments.

The ion detector may be physically configured to increase or decrease a vacuum conductance thereof compared with a similar or otherwise identical ion detector of the prior art that is not so configured. Preferably the ion detector is configured to decrease vacuum conductance so as to inhibit or prevent the movement of a contaminant from the environment external the detector to the environment about the electron emissive surface(s) and/or the electron collector surface.

The ion detector may be physically configured to allow for user control of a vacuum conductance of the ion detector.

The ion detector may be physically configured to exploit the molecular flow conditions of a mass spectrometer vacuum chamber. A detector configured in this way may take advantage of the molecular flow conditions of a gas flowing external to internal the ion detector.

The ion detector may be physically configured to, or comprising physical means for sustaining a lowered pressure internal the ion detector.

The ion detector enclosure may be formed from about 3 or less enclosure portions, or about 2 or less enclosure portions, or is formed from a single piece of material. The enclosure may comprise one or more discontinuities.

In one embodiment of the first aspect, the ion detector comprises means for interrupting a flow of a gas external the ion detector into one or all of the one or more discontinuities. In respect of the at least one of the one or more discontinuities, or all of the one or more discontinuities, may be dimensioned so as to limit or prevent entry of a gas external the ion detector into the ion detector. The at least one of the one or more discontinuities, or all of the one or more discontinuities, may be no larger than is required for its/their function(s).

At least one of the one or more discontinuities, or all of the one or more discontinuities, may be positioned on the enclosure and/or orientated with respect to the ion detector so as to limit or prevent entry of a gas external the ion detector into the ion detector.

At least one of the one or more discontinuities, or all of the one or more discontinuities may have a gas flow barrier associated therewith. At least one of the gas flow barriers, or all of the gas flow barriers, may be configured so as to limit or prevent the linear entry of a gas external the ion detector into the ion detector. At least one of the gas flow barriers, or all of the gas flow barriers may comprise one or more walls extending outwardly from the periphery of the discontinuity. At least one of the gas flow barriers, or all of the gas flow barriers may be elongate and/or slender. At least one of the gas flow barriers, or all of the gas flow barriers, may comprise one or more bends and//or one or more 90 degree bends,

At least one of the gas flow barriers, or all of the gas flow barriers, may comprise a baffle. At least one of the gas flow barriers, or all of the gas flow barriers, may be formed as a tube having an opening distal to the discontinuity. The opening distal to the discontinuity may be positioned on the tube and/or orientated with respect to the ion detector so as to limit or prevent entry of a gas external the ion detector into the ion detector.

At least one of the gas flow barriers, or all of the gas flow barriers mat be curved and/or devoid of corners on an external surface thereon. An external surface of the enclosure is curved, or comprises a curve, and/or is devoid of a corner.

The ion detector may comprise an internal baffle which may interrupt a line of sight through the ion detector.

The ion detector may comprise an input aperture, wherein the input aperture has a cross-sectional area less than about 0.3 cm². The ion detector may be configured such that no line of sight through the ion detector exists.

The ion detector may be in functional association with an off-axis input ion optic apparatus, configured to inhibit or prevent the stagnation of a gas about the ion detector. The off-axis ion input optic apparatus may be configured to allow the substantially free flow of a gas therethrough. The off-axis ion input optic apparatus may comprise an enclosure, the enclosure comprising one or more discontinuities positioned or orientated so as to prevent the stagnation of a gas about the ion detector and/or allow the substantially free flow of a gas therethrough.

The ion detector may be configured to operate such that a gas flowing external to internal the ion detector and/or from internal to external the ion detector has the flow characteristics of a conventional fluid and/or does not have the flow characteristics of molecular flow.

Thus, the ion detector may have one or a combination of features which cause or assist in an alteration of vacuum conductance of a detector. The detector may be embodied in the form of: a sealed detector, a .partially sealed detector; a detector with one or more gas flow barriers; a detector associated with appropriately designed off-axis input optics that shunts any gas flows present away from the detector; a detector comprising one or more gas flow barriers in association with appropriately designed off-axis input optics that shunts any gas flows present away from the detector; a detector comprising a discontinuity such as a vent, a grill, an opening and/or apertures to prevent a localised build-up of gas in a detector with a line-of-sight input aperture; a detector comprising one or more gas flow barriers that further comprises a discontinuity such as a vent, a grill, an opening and/or an aperture to prevent a localised build-up of gas in a detector with a line-of-sight input aperture; a detector using adjustable (and preferably movable) gas flow barriers to maximise conductance during pump down, and minimise conductance during operation.

It is emphasized that the physical characteristics of the detector or the input optics are not essential elements of the present invention, however when combined with the present invention may provide further advantage.

In order to more fully describe the present invention, reference is now made to the following non-limiting illustrative examples.

### EXAMPLES

The exemplary embodiments disclosed infra relate to methods whereby the arrival of ion mass peaks entering the detector are deliberately arranged to maximise the detector's pumping of its internal volume; or to minimise the time available for contaminant molecules from the external environment to move into the internal environment of the detector (the recovery time) and replenish the contaminant molecules back to equilibrium. The former is achieved by arranging the arrival of the incident ion masses as closely together as possible in time (particularly for those masses with the highest signal levels). This maximises the amount of pumping achieved when the detector operates. The latter is achieved by deliberately staggering the ion arrivals to minimise the recovery time available to the detector. In both cases, this is likely to require arranging the arrival of ions consecutively in time, that are not sequential when arranged in either ascending or descending mass. In both cases the method arranges advantageous arrivals of ions that are not necessarily still sequential in mass. This may be referred to as “mass hopping.”

As discussed elsewhere herein, in the prior art the arrival of ions at the detector is not arranged with any consideration to the effect on detector operating lifetime or detector performance Ions are typically arranged to arrive in either ascending or descending mass. This is the most convenient way to operate quadrupole and ion trap mass analysers. It is the only way to operate a time of flight system. By design time-of-flight systems separate ions in time according to their mass in a continuous fashion.

FIG. 1 shows a representative arrangement of ion arrival times in a quadrupole system typical of the prior art. The mass range is scanned sequentially, with gaps occurring on a frequent, semi-regular basis. These gaps can be intentional, which allows for tasks such as on-the-fly processing, or the result of system dead time. It is common for masses to have no signal in reality. Some of the mass peaks in this figure contain no signal. This has the effect of creating additional or extending existing intervals where no masses arrive at the detector.

When the mass range is scanned sequentially, the masses within the sample will determine the time intervals that the detector is “on” and “off”. The detector effectively pumps its internal environment when in the ‘on’ state. Subsequently, when the detector is in the ‘off’ state, the internal environment re-establishes equilibrium with the external environment.

Mass hopping maximises the time that a detector operates with a superior (i.e. clean) internal environment. When mass hopping the arrival of ions achieve one or both of the following. First, the duration of consecutive ion arrivals can be maximized. The goal is to compound the pumping effect of the ions as they arrive within a given interval. This may be termed ‘bunching’ or ‘bunched mass hopping’. Second, the ion arrivals can be staggered to match the relaxation time of the detector. The goal is to limit the amount of time available for the internal and external environments to reach equilibrium. This may be refer to as ‘staggering’ or ‘staggered mass hopping’. In both approaches there is decoupling of the internal and external detector environments.

Determining which of these two approaches, or the combination, that is most appropriate for a given system and sample will depend upon various factors. This includes the mass slew/switching speed of the system and any sensitivity and throughput requirements. Another major factor is the conductance of the detector. It may be expected that as detector vacuum conductance increases, bunching becomes more effective than staggering. This is because the correspondingly stronger coupling of the internal and external detector environments, requires more effective pumping of the internal environment.

A further optimisation exists irrespective of which approach, or combination of the two, is being pursued. It is possible to further optimise the arrival of ions within a given arrival window by ensuring that the ions are arranged in order of decreasing signal, after a maximum signal. This may be referred to as ‘spiking’ or ‘spiked mass hopping’. A spiked mass hopping sequence will pump the internal detector environment as quickly as possible. This will maximise the time that the detector operates with a superior internal environment. This achieves a higher level of decoupling of the internal and external detector environments.

An important application of mass hopping is to decouple the internal and external detector environments. This may be achieved using a combination of bunched, staggered and spiked ion arrivals. Using a combination of these three a cleaner internal detector environment can be created, and sustained for a longer time, than would have been achieved with a conventional scan. This effectively decreases the coupling between the internal and external detector environments. This cleaner internal environment primarily extends the operating life of the multiplier. The secondary benefits, depending on how the detector is operated, also include reduced noise, greater sensitivity, increased dynamic range and reduced ion feedback.

The benefit of combining bunching, staggering and spiking is that the unavoidable dead times and the performance limitations of the quadrupole can be accommodated.

For example, it may not be possible for a given quadrupole to bunch together all of the masses with significant output signal. In this situation the ions may be bunched into the fewest groups possible, while staggering these groups to limit the ‘off’ intervals to <=3× the detector relaxation time. The ions within each group would then be spiked as much as possible.

In another example, it may not be possible to limit ‘off’ intervals to <=3× the detector relaxation time. In this instance, bunching may be used to exploit the fact that lengthening ‘off’ intervals beyond ˜4× the relaxation time has no further effect. Longer ‘off’ intervals have no additional effect once the ‘off’ interval is long enough for a detector's internal and external environments to equilibrate. In practise, bunching is used to eliminate smaller ‘off’ intervals to lengthen ‘off’ intervals that are already sufficiently long to achieve equilibrium.

### Example 1: Configuration of Ion Impact Timing to Cause Grouping of Ion Masses having a Signal Away from Ion Masses having No Signal

Reference is made to FIG. 2. A mass spectrometer initially sequentially scans through the possible ion mass range in pre-run-time. As signal is recorded it is analysed to determine the masses for which large output signals, which corresponds to high numbers of input ions, are observed. The sequence of ion masses is then configured at run-time to bunch these masses together. It will be noted that at run-time the ions mass having a signal (i.e. species labelled 1, 2, 3, 4, 5, 7, 8, 9, 10, 12, 15, 16, 17, 18, 19 and 20) are grouped together, and caused to impact the detector surface first, and in mass sequence. Ion masses having no sequence (i.e. species labelled 6, 11, 13 and 14) are timed to impact as a second group. It will be appreciated that the spectrum of FIG. 2 is a re-arrangement of the prior art spectrum shown in FIG. 1.

In this embodiment higher levels of electron pumping (due to electron flux) will be seen at the earlier times given the concentration of ion impacts over a shorter time period. At later times, electron flux has stopped and so pumping is diminished. However, the high level of pumping seen in the earlier period may cross a threshold such that as many ions as possible arrive while the detector internal environment is as clean as possible.

This approach of grouping ion masses does not necessarily apply to the delineation of those having signal with those having no signal. Similar effects (albeit possibly lesser effects) may be expected where, for example, all ion masses have a signal and the higher signal ion masses are delineated in first group away from ion masses having low signals in a second group.

### Example 2: Configuration of Ion Impact Timing to Cause Grouping of Ion Masses to Avoid Impact During Detector Relaxation Period

In this embodiment, a mass spectrometer initially sequentially scans through the expected ion mass range. As signal is recorded it is analysed to determine the masses with large output signals, which corresponds to high numbers of input ions. The sequence of ion masses is then configured at run-time to stagger these masses in time to be separated by no greater than three times the detector's relaxation time. In this embodiment the detector “off” times created by these separations are synchronised to the detector relaxation times. As will be appreciated, the spectrum of FIG. 2 is a re-arrangement of that in FIG. 1.

Grouping ion masses and synchronising the impacts of the grouped masses so as to avoid or precede the periodic relaxation time of a detector provides practical advantage. The clean internal environment of the detector may be exploited for as long as possible before the internal and external detector environments re-equilibrate. To achieve this aim, the method may be performed such that the next group of ions arrive before equilibrium is achieved. By that method, it is possible to start pumping from a better position (in terms of interior cleanliness) as compared to the previous position. In the longer term, this approach may achieve a cleaner internal detector environment than would otherwise be the case for the same detector relaxation time.

### Example 3

### Configuration of Ion Impact Timing to Cause a Signal Spike

In this embodiment, a mass spectrometer initially sequentially scans through the expected ion mass range. As signal is recorded it is analysed to determine the masses with large output signals, which corresponds to high numbers of input ions. The ions within the individual groups are arranged in order of decreasing signal to create a ramp-like formation having a peak at the start. It will be appreciated that the spectrum shown in FIG. 4 is a re-arrangement of that shown in FIG. 1.

In FIG. 4 the ions masses have been timed to impact the electron emissive surface of the detector in several groups. For example, one group comprises the ion species marked 5, 3, 1, 2 and 4. The species within that group have been arranged in a ramp-like formation which is maximum in terms of signal at the first species (5) of the group and decreases sequentially to the last species (4) in the group. The impact of the first group causes a rapid increase in ion flux, and therefore a rapid increasing in detector pumping. The electron flux decreases over time, and after impact of the last species (5) in the group ceases for a period. The first species (9) of the second group then impacts, again leading to a rapid increase in electron flux, and therefore an increase detector pumping.

As an alternative to the arrangement shown in FIG. 4, the ion masses are arranged sequentially so as to increase up to peak, followed by a decline.

It will be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. Functionality may be added or deleted from the diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

1. A method for operating an ion detector, the method comprising:
providing an ion stream comprising ions having a range of masses,
separating the ions of the ion stream on the basis of mass, and
controlling timing and/or order of impact of the separated ions on an electron emissive surface of the ion detector so as to modify one or more parameters of the ion detector.

2. The method of claim 1, wherein one of the one or more parameters of the ion detector is electron flux.

3. The method of claim, wherein one of the one or more parameters of the ion detector is a time that the electron emissive surface is impacted with ions during detector run time, compared with a time the detector is not impacted with ions during detector run time.

4. The method of claim 1, wherein one of the one or more parameters of the ion detector is a level of detector pumping or a level of fouling of the electron emissive surface with a contaminant.

5. The method of claim 1, wherein the detector is configured to define an internal detector environment and an external detector environment, and one of the one or more parameters of the ion detector is a coupling or uncoupling of the internal detector environment and an external detector environment.

6. The method of claim 1, wherein one of the one or more parameters of the ion detector is a performance parameter or a service life parameter, and the modification is an improvement in the performance parameter or the service life parameter.

7. The method of claim 1, comprising controlling the impact of the separated ions on the electron emissive surface such that a sequence of ion species impacting is such that an order of at least three of the ion species is not in an ascending or descending order according to mass.

8. The method of claim 1, comprising controlling the impact of the separated ions on the electron emissive surface such that:
(i) a sequence of ion impact is modified compared with a method of operation whereby ions impact in ascending or descending sequence according to mass, and/or (ii) the sequence of ion impact is modified so as to form an ion signal maximum, and/or
(iii) the timing of ion impact is modified according to a timing of a relaxation period of the detector, and/or
(iv) the timing of ion impact is modified so as to shorten or lengthen a time period between the impact of two ions of different mass.

9. The method of claim 8, wherein the modification is compared to a method of detector operation whereby (a) ions impact in ascending or descending sequence according to mass or (b) ions impact at a time according to a linear scanning of the ion stream.

10. A method for operating an ion detector, the method comprising:
providing an ion stream comprising ions having a range of masses,
separating the ions of the ion stream on the basis of mass,
controlling a sequence and/or timing of impact of the separated ions on an electron emissive surface of the ion detector so as regulate a time that the detector is impacted with ions compared with a time the detector is not impacted with ions during detector run time.

11. The method of claim 10, wherein the ion detector is structured so as to provide an internal detector environment and an external detector environment, and wherein the controlling causes an alteration in coupling between the internal detector environment from an external detector environment.

12. (canceled)

13. The method of claim 10, wherein the ion detector is structured so as to provide an internal detector environment and the external detector environment, and wherein the controlling causes an alteration in pumping of the internal detector environment.

14. (canceled)

15. The method of claim 10, wherein the ion detector is structured so as to provide an internal detector environment and the external detector environment, and wherein the controlling causes an alteration in a time for which an equilibrium is established and/or re-stablished between the internal detector environment and the external detector environment after an alteration in coupling between the internal detector environment to the external detector environment.

16. (canceled)

17. The method of claim 10, wherein the controlling controls the timing of impact of ions on the electron emissive surface of the ion detector.

18. The method of claim 17, wherein the timing of impact of ions on the electron emissive surface of the ion detector is such that (i) an order of impact of ions is not sequential according to the masses of the ions, or (ii) an interval between any two or more ions impacting is altered as compared to the situation where the ion stream is scanned in an ascending or descending manner by mass.

19. (canceled)

20. (canceled)

21. The method of claim 17, wherein the timing of impact of ions on the electron emissive surface of the ion detector is such that a series of ions form an ion signal maximum.

22. The method of claim 21, wherein the ion signal maximum has a maximum at a start of a series of ion signals.

23. The method of claim 10, comprising altering an order of impact of ions on the electron emissive surface of the ion detector so as to differ from an order impact as compared to a situation where the ion stream is scanned in an ascending or descending manner by mass.

24. An analytical instrument comprising:
sample ionization means,
ion directing means,
ion controlling means, and
ion detection means,
wherein the ion directing means is configured to direct an ion stream from the sample ionization means toward the ion detection means, and the ion controlling means is configured so as to alter a parameter of the ion detection means.

25. The analytical instrument of claim 24, wherein the ion controlling means is configured to alter an order of impact of ions on the ion detection means so as to (i) differ from an order of impact where the ion stream is scanned in an ascending or descending manner by mass or (ii) alter a timing of impact of ions on the ion detection means so as to differ from a timing of impact where the ion stream is scanned in an ascending or descending manner by mass.
